(19) United States
(12) Patent Application Publication
(10) Pub. No.: US 2007/0008944 A1
(43) Pub. Date: Jan. 11, 2007

(54) Method and system for spreading and scrambling downlike physical channels

(76) Inventor: Qian Zhang, Walpole, MA (US)

Correspondence Address: GAUTHIER & CONNORS, LLP, 225 FRANKLIN STREET, SUITE 2300, BOSTON, MA, 02110, US

(21) Appl. No.: 11/175,664

(22) Filed: Jul. 6, 2005

(51) Int. Cl. H04B 7/216

(52) U.S. Cl. 370/342

(57) ABSTRACT

A method is disclosed for reducing the number of channels required in a transmission system that employs a plurality channels for communicating with multiple receiver stations. The method includes the steps of partitioning the plurality of channels into a plurality of groups with each group including a set of channels, and partially spreading and combining the sets of channels within each respective group into a new group channel for each respective group.

### BACKGROUND

The invention generally relates to communication systems, and relates in particular to transmission systems for mobile communication systems.

Certain cellular mobile communication systems employ multiplexing techniques, such as wideband code division multiple access (WCDMA), to provide spectral efficiency and to reduce interference at receiver stations such as mobile units. In cellular mobile communication systems employing WCDMA, each signal to be transmitted from the base station is spread over a wide bandwidth at the base station using a unique spreading code. Each mobile unit de-spreads one of the wide bandwidth signals back to the original signal using a replica of the spreading code that was used to spread that original signal. Other wide bandwidth signals that were spread with different spreading codes are not de-spread at that mobile unit.

For example, U.S. Published Patent Application 2002/0150065 discloses a universal mobile telecommunications system (UMTS) employing a frequency division multiplexing (FDD) mode in which a base station includes a transmitter and transmission signal processing units that include spreaders and scrambler. Each signal is disclosed to be multiplied by a spreading code that is unique for a particular mobile unit in. Each of the transmission signals is also scrambled by a scrambling code wherein the scrambling code is unique to that base station.

U.S. Pat. No. 6,665,228 discloses a method and apparatus for reducing synchronization code interference in a WCDMA communication system, in part, by transmitting information on an additional channel to reduce interference attributable to the synchronization code, which is transmitted on a different channel. U.S. Published Patent Application No. 2003/0103478 discloses a system and method for determining whether a requested new channel to be set up is already in use in a WCDMA communication system.

The setting up of new channels, however, is not always possible if the basestation is unable to assign a new spreading code to the new channel. U.S. Published Patent Application 2003/0081584 discloses a method and system for downlink channelization code allocation in a UMTS in which an orthogonal variable spreading factor (OVSF) is assigned to each new channel while maintaining previously assigned OVSF codes. This is disclosed to be achieved by providing reserved codes in the generation and release of OVSF codes.

Such transmission systems, however, typically perform spreading on a channel by channel basis. For example, channelization codes may be uniquely described as C_{ch,SF,m}, where SF is the spreading factor of the code and m is the code number (0≦m≦SF−1). Each level in a code tree defines channelization codes of length SF, corresponding to a spreading factor of SF. Different spreading factors are used according to the rate of each user (e.g. 4≦SF≦512). As shown, for example, in FIG. 1, spreading and scrambling may be conventionally achieved in a downlink physical channel by subjecting the channel to complex multiplexing into I and Q channels that are first multiplied by a channelization code vector. Each element of the code vector is either +1 or −1. The size of the code vector is an integer power of 2. Each pair of two consecutive symbols is first serial-to-parallel converted (at 10) and mapped (at 12) to the I and Q branches. The I and Q branches are then spread to the chip rate by the same real-valued channelization code (14) at combiners 16 and 18 respectively. The values on the Q branch are then combined with a variable j at 20, and the sequences of real-valued chips on the I and Q branch are then treated as a single complex-valued sequence of chips as provided at 22. The sequence of chips is then scrambled by a complex-valued scrambling code S_{dl,n} (as shown at 24) wherein each element of the scrambling code vector (in the form ±1±i) and are provided at node 28 by combiner 26. The different downlink channels (as shown at 28 and 28′ in FIG. 2) are combined at combiner 38 where each complex-valued spread channel (corresponding to points 28 and 28′) is separately weighted by a weight factor G₁ (e.g., G₁ as shown at 32 and G₂ as shown at 36) by combiners 30 and 34. The complex-valued P-SCH and S-SCH are separately weighted by weight factors Gₚ (shown at 42) and Gₛ (shown at 44) by combiners 40 and 44, and the channels are all combined at 48 to provide a combined multi-channel output at node 50. All downlink physical channels are then combined using complex addition.

In such channel by channel spreading systems however, the material and processing costs are generally proportional to the number of channels. There is a need, therefore, for more efficient and cost effective implementation of a transmission system for mobile communication systems.

### SUMMARY OF THE INVENTION

In accordance with an embodiment, the invention provides a method for reducing the number of channels required in a transmission system that employs a plurality channels for communicating with multiple receiver stations. The method includes the steps of partitioning the plurality of channels into a plurality of groups with each group including a set of channels, partially spreading and combining the sets of channels within each respective group into a new group channel for each respective group. In certain embodiments, the method further includes the steps of partitioning said group channels into sub-group channels, partially spreading and combining the sub-group channels, and spreading and scrambling the sub-group channels. In certain embodiments, the method further includes the step of spreading and scrambling the group channels or sub-group channels, as well as the step of combining the group channels or the sub-group channels for output to a transmitter node.

### BRIEF DESCRIPTION OF THE DRAWINGS

The following description may be further understood with reference to the accompanying drawings in which:

FIG. 1 shows a diagrammatic illustrative view of a spreading and scrambling system for a downlink physical channel in a communication system of the prior art;

FIG. 2 shows a diagrammatic illustrative view of a spreading and modulation system in which different downlink physical channels are combined in a communication system of the prior art;

FIG. 3 shows a diagrammatic illustrative view of a code tree for generating OVFS codes in a communication system in accordance with an embodiment of the invention;

FIG. 4 shows a diagrammatic illustrative view of a spreading and scrambling system for a downlink physical channel in a communication system in accordance with an embodiment of the invention; and

FIG. 5 shows a diagrammatic illustrative view of a spreading and modulation system in which different downlink physical channels are combined in a communication system in accordance with an embodiment of the invention.

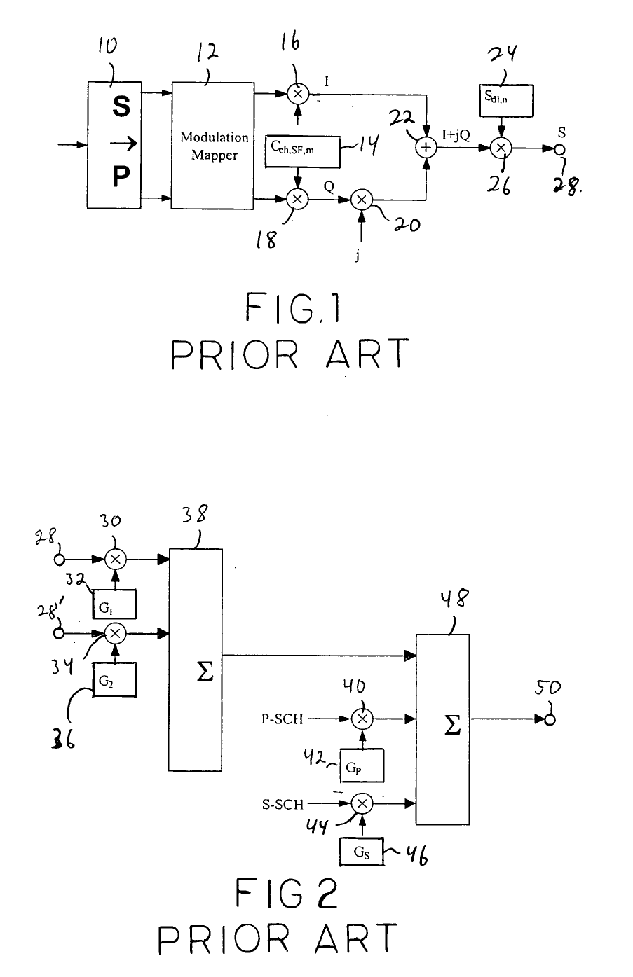

The drawings are shown for illustrative purposes only.

### DETAILED DESCRIPTION OF THE ILLUSTRATED EMBODIMENTS

In accordance with certain embodiments, the invention provides that the spreading and scrambling process may be broken up into multiple stages. In each stage, the channels are partitioned into several groups. Within each group, the channels in the group are partially spread and combined into a new channel. As a consequence, there are fewer channels in the next stage. The partial spreading and combining operation is repeated in all stages except the last stage. In the last stage, the newly created channels are spread, scrambled and combined from the previous stage into one data stream that will be sent to the radio frequency (RF) processing unit. The partial spreading and combining technique decreases the effective channel count in the overall spreading/scrambling process, and therefore, reduces the total processing cost. If the number of channels N is large, the system may reduce the processing cost by a factor of N/4. For example, if the number of downlink channels is equal to 100 (e.g., in a typical voice application), the processing cost may be reduced by a factor of 25 (or by 95%). In voice applications in UMTS-FDD of WCDMA, spreading and scrambling may account for most of the processing cost in the downlink.

In accordance with an example, a system of the invention may provide a first stage in which partially spread channels in a sub tree rooted at C_{ch,8,k} are combined into an equivalent channel with channelization code C_{ch,8,k} where k=0 to 7. A gain value of Gᵢ is then applied to an input channel. The input channels may have different gain values. In the second stage, the eight equivalent channels C_{ch,8,k} where k=0 to 7 are again spread, scrambled and combined. The methodology of the invention may be applied in many further stages.

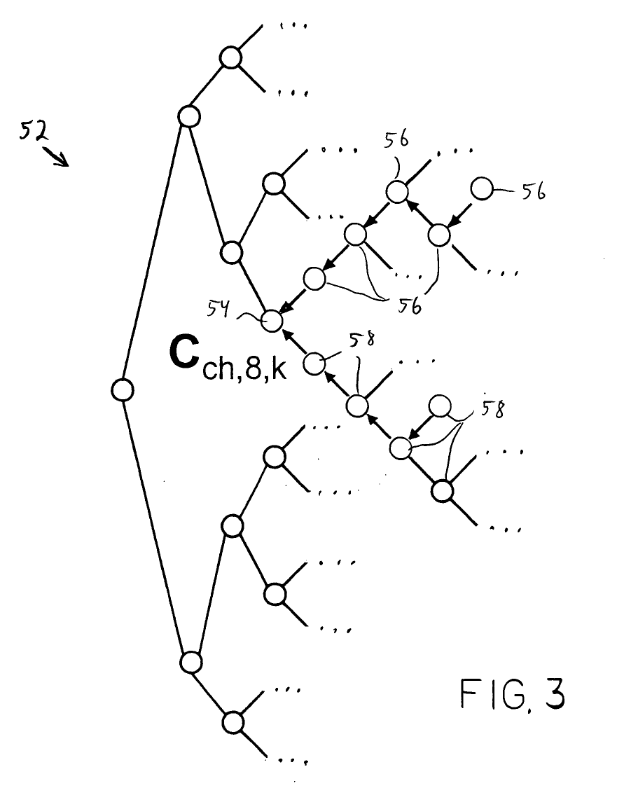

For example, as shown in FIG. 3, an OVSF code tree 52 in accordance with an embodiment of the invention may include a node C_{ch,8,k} (54) that is provided by a first group 56 and a second group 58. Since up to eight channels may be spread with C_{ch,8,k} where k=0 to 7, every channelization code may be made of C_{ch,8,k,} so the partial spreading codes are provided by C_{ch,SF,m}=[C_{ch,8,k}+C_{ch,8,k} . . . ±C_{ch,8,k}]=C_{ch,8,k} \textcircled{x} C_{ch,SF/8,mod(m,SF/8)} where the operator \textcircled{x} represents the Kronecker product, and operation mod(x,y) represents the remainder of x divided by y. In particular, a first group, e.g., C_{ch,256,n} (not shown) is provided by C_{ch,256,n}=C_{ch,8,k} \textcircled{x} C_{ch,32,mod(n,32)}. This product for the first group is then spread by a spreader with one symbol to provide an output for the first group that involves 32 symbols. A second group, e.g., C_{ch,128,p} (not shown) is provided by C_{ch,128,p}=C_{ch,8,k} \textcircled{x} C_{ch,16,mod(p,16)}. This product for the second group is then spread by a spreader with two symbols to provide an output for the second group that involves 32 symbols. The partial spreading codes are provided by C_{ch,32,mod(n,32)} and C_{ch,16,mod(p,16)}. The residual spreading code for the outputs of the first and second groups (C_{ch,8,k}), are then combined to provide an equivalent channelization code (C_{ch,8,k}) using 32 symbols.

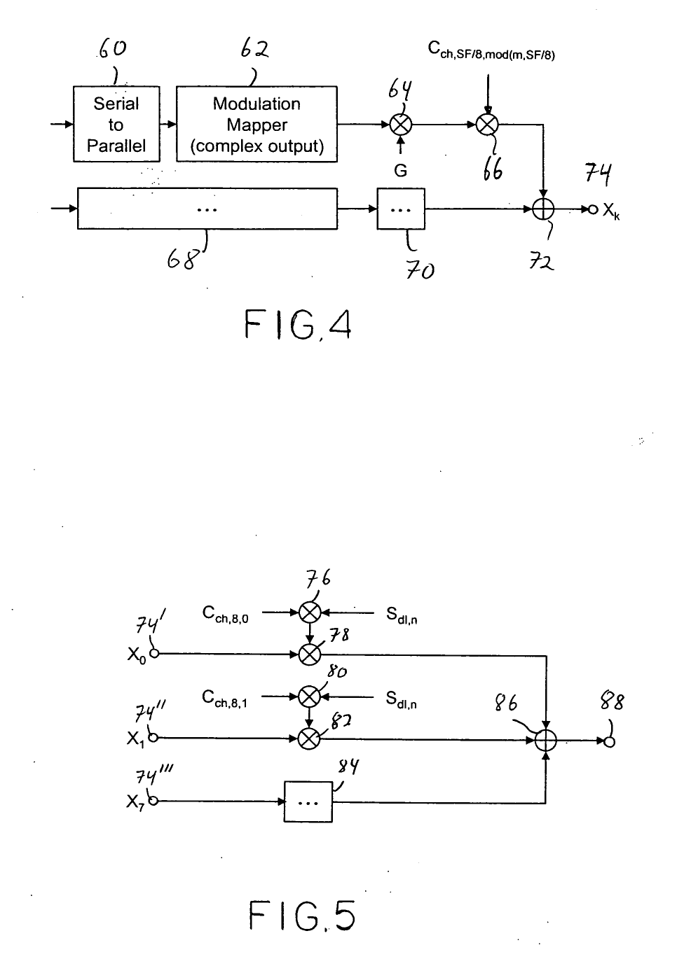

The partial spreading and combining are shown in FIG. 4 in which each pair of two consecutive symbols is first serial-to-parallel converted (at 60) then mapped (at 62), and weighted by a weight factor G as shown at 64. A partial spreading code of C_{ch,SF/8,mod(m,SF/8)} is then applied as shown at 66, and the remaining channels are similarly processed (as shown at 68 and 70) for that group and then combined at 72 to provide a group output at node 74 for group Xₖ where k=0 to 7.

The further spreading, scrambling and combining for the outputs 74′, 74″ 74′″ etc. of groups X₀-X₇ are provided as shown in FIG. 5. In particular, combiners 76 and 78 apply spreading and scrambling codes of C_{ch,8,0} and S_{dl,n} for group one (X₀), and combiners 80 and 82 apply spreading and scrambling codes of C_{ch,8,1} and S_{dl,n} for group two (X₁). The remaining groups are similarly spread and scrambled as generally shown at 84. The outputs of these eight groups are then combined by the combiner 86 to provide the output for the transmission system at node 88.

Those skilled in the art will appreciate that numerous modifications and variations may be made to the above disclosed embodiments without departing from the spirit and scope of the invention.

What is claimed is:

1. A method for reducing the number of channels required in a transmission system that employs a plurality channels for communicating with multiple receiver stations, said method comprising the steps of:
partitioning the plurality of channels into a plurality of groups, each group including a set of channels; and
partially spreading and combining the sets of channels within each respective group into a new group channel for each respective group

2. The method as claimed in claim 1, wherein said method further includes the step of spreading and scrambling the group channels.

3. The method as claimed in claim 2, wherein said method further includes the step of combining the group channels for output to a transmitter node.

4. The method as claimed in claim 1, wherein said method further includes the step of partitioning said group channels into sub-group channels with each sub-group including a sub-set of channels.

5. The method as claimed in claim 4, wherein said method further includes the step of partially spreading and combining the sub-set of channels within each respective sub-group into a new sub-group channel.

6. The method as claimed in claim 5, wherein said method further includes the step of spreading and scrambling the sub-group channels.

7. The method as claimed in claim 6, wherein said method further includes the step of combining the sub-group channels for output to a transmitter node.

8. The method as claimed in claim 1, wherein said sets of channels in each group are spread by applying a spreading code of C_{ch,G,k} \textcircled{x} C_{ch,SF/G,mod(m,SF/G)} wherein G is the number of groups.

9. The method as claimed in claim 1, wherein said plurality of channels is partitioned into eight groups.

10. The method as claimed in claim 9, wherein said sets of channels in each group are spread by applying a spreading code of C_{ch,8,k} \textcircled{x} C_{ch,SF/8,mod(m,SF/s)}.

11. A method for reducing the number of channels required in a transmission system that employs a plurality channels for communicating with multiple receiver stations, said method comprising the steps of:
partitioning the plurality of channels into a plurality of groups, each group including a set of channels;
partially spreading and combining the sets of channels within each respective group into a new group channel for each respective group;
partitioning the plurality of groups channels into a plurality of sub-groups, each sub-group including a sub-set of channels;
partially spreading and combining the sub-sets of channels within each respective sub-group into a new sub-group channel for each respective sub-group;
spreading and scrambling the sub-group channels; and
combining the sub-group channels for output to a transmitter output node.

12. The method as claimed in claim 11, wherein said steps of partitioning the plurality of groups channels into a plurality of sub-groups, and partially spreading and combining the sub-sets of channels within each respective sub-group are repeated.

13. The method as claimed in claim 11, wherein said sets of channels in each group are spread by applying a spreading code of C_{ch,G,k} \textcircled{x} C_{ch,SF/G,mod(m,SF/G)} wherein G is the number of groups.

14. A method for reducing the number of channels required in a transmission system that employs a plurality channels for communicating with multiple receiver stations, said method comprising the steps of:
partitioning the plurality of channels into a plurality of groups, each group including a set of channels; and
partially spreading and combining the sets of channels within each respective group into a new group channel for each respective group, wherein said sets of channels in each group are spread by applying a spreading code of C_{ch,G,k} \textcircled{x} C_{ch,SF/G,mod(m,SF/G)} wherein G is the number of groups
spreading and scrambling a final group channels; and
combining the final group channels for output to a transmitter node.

15. A system for reducing the number of channels required in a transmission system that employs a plurality channels for communicating with multiple receiver stations, said system comprising:
partitioning means for partitioning the plurality of channels into a plurality of groups, each group including a set of channels; and
partial spreading and combining means for partially spreading and combining the sets of channels within each respective group into a new group channel for each respective group.

16. The system as claimed in claim 15, wherein said system further includes a spreading and scrambling means for spreading and scrambling the group channels.

17. The system as claimed in claim 16, wherein said sets of channels in each group are spread by applying a spreading code of C_{ch,G,k} \textcircled{x} C_{ch,SF/G,mod(m,SF/G)} wherein G is the number of groups.

18. The system as claimed in claim 17, wherein the number of groups G is 8.
